(19) United States
(12) Patent Application Publication
(10) Pub. No.: US 2025/0155119 A1
(43) Pub. Date: May 15, 2025

(54) COMBUSTION PROCESS USING A HYDROGEN-NITROGEN MIXTURE AS FUEL GAS

(71) Applicant: TECHNIP ENERGIES FRANCE, Nanterre Cedex (FR)

(72) Inventors: Izaak Jacobus RISSEEUW, Nanterre Cedex (FR); Maria LIOUTA, Nanterre Cedex (FR); David VERGE, Nanterre Cedex (FR); Stéphane WALSPURGER, Nanterre Cedex (FR)

(21) Appl. No.: 18/839,912

(22) PCT Filed: Feb. 23, 2023
(86) PCT No.: PCT/EP2023/054553

§ 371 Date: Aug. 20, 2024

(30) Foreign Application Priority Data
Feb. 23, 2022 (EP) 22290008.6

(51) Int. Cl. F23C 1/00; F23L 7/00

(52) U.S. Cl. CPC F23C 1/00; F23L 7/00; F23C 2900/9901

(57) ABSTRACT

Combustion process, comprising: a) a production step of a binary fuel gas consisting of hydrogen and at least of between 5 and 50 vol % of nitrogen, preferably between 15 and 35 vol % nitrogen, and b) a combustion step using as only fuel gas the binary fuel gas at a combustion chamber able to receive as fuel gas the binary fuel gas, wherein the combustion chamber is selected from the group of furnaces and fired process heaters.

The present invention relates to a fuel gas, a combustion process using this fuel gas and a combustion plant able to receive this fuel gas and suitable for carrying out such a process.

In particular, the present invention relates to a combustion process without carbon dioxide emission.

Burning of fossil fuels such as natural gas contribute to carbon dioxide emission, which is a greenhouse gas.

The carbon dioxide emission can be avoided by using renewable energy or burning fossil fuel in combination with carbon capture and storage (sequestration).

Conventional methods for carbon free fuel combustion utilize pure hydrogen gas or ammonia fuel.

Hydrogen is projected to play a central role in the future of energy. Hydrogen should be produced either from renewable energy or from fossil fuels in combination with carbon capture and storage.

However, hydrogen fuel has the following disadvantages:
High cost due to fuel quality requirement,
High peak flame temperature and high NOx emission,
The burning velocity of hydrogen fuel is too high,
Hydrogen fuel generates less flue gas compared to natural gas or methane fuel. As a result of this furnaces, that are designed for natural gas fuel will lack flue gas mass velocity and flue gas enthalpy in the convection section.

The present invention aims to overcome these drawbacks and provide a new combustion process.

A solution of the present invention is a binary fuel gas consisting of hydrogen and at least of between 5 and 50 vol % of nitrogen.

Advantageously, the binary fuel gas according to the present invention comprises of between 15 and 35 vol % of nitrogen, preferably between 20 and 30 vol % of nitrogen.

According to the present invention, the expression “binary fuel gas” means that the fuel gas has two main constituents—hydrogen and nitrogen—and comprises no pollutant or a small amount of pollutants such as NH3, CO, CO2, CH4, C2H6 total <1 vol %.

Another object of the present invention is a combustion process using as only fuel gas the binary fuel gas as defined in the present invention.

Advantageously, the process according to the invention comprises:
a) a production step of the binary fuel gas,
b) a combustion step using as only fuel gas the binary fuel gas.

In an embodiment the combustion process comprises a) a production step of a binary fuel gas consisting of hydrogen and at least of between 5 and 50 vol % of nitrogen, and b) a combustion step using as only fuel gas the binary fuel gas at a combustion chamber able to receive as fuel gas the binary fuel gas, wherein the combustion chamber is selected from a furnace or a fired process heater.

Depending on the case, the process according to the invention comprises one or more of the following features:
the production step a) comprises an electrolysis sub-step to produce hydrogen, a cryogenic air separation sub-step to produce nitrogen and a hydrogen and nitrogen mixing sub-step;
the production step a) comprises an ammonia cracking sub-step; Ammonia cracking is the process by which ammonia is decomposed towards hydrogen and nitrogen over a catalyst;
the process comprises a NOx removal sub-step; For example, a selective catalytic reduction (SCR) can be used. SCR consists in the reduction of Nitrogen Oxides (NOx) by injection of ammonia or urea (liquid) upstream a catalyst.
the production step a) comprises at least one of the following sub-steps: steam methane reforming, autothermal reforming and partial oxidation;
the feedstock used in the production step is chosen from natural gas, Liquified Petroleum Gas (LPG), naphta, gasoil, diesel, gas condensate and biogas;
The production step a) comprises a purification sub-step of the feedstock. For example, the purification sub-step comprises an hydro-desulphurization and/or a purification by absorption in order to remove sulfur and chlorine.
the production step a) comprises the following sub-steps: a cooling sub-step, a water gas shift sub-step and a carbon dioxide removal sub-step; The water gas shift sub-step is called “CO shift sub-step”.
the production step a) comprises a pre-reforming sub-step;
the carbon dioxide removal sub-step is a chemical absorption sub-step using a solvent such as aqueous amine solution;
the process comprises a heat recovery step. For example, heat recovery from the hot flue gas leaving the combustion chamber e.g. by a combustion air preheater or a convection section to recover heat from the flue gas and heat up the feed gas. With pinch technology all streams can be evaluated on heat content.

Another object of the present invention is a combustion plant comprising a combustion chamber able to receive as only fuel gas the binary fuel gas as defined in the present invention.

Advantageously, the combustion plant comprises:
i) A production unit of the binary fuel gas,
ii) A combustion chamber able to receive as fuel gas the binary fuel gas.

Note later the combustion chamber can be assimilated to a furnace. In fact, a furnace always has a combustion chamber where heat is generated and recovered.

In an embodiment the combustion plant comprises i) a production unit configured to produce the binary fuel gas as defined herein, ii) a combustion chamber, selected from selected from a furnace or a fired process heater, able to receive as only fuel gas fuel gas the binary fuel gas.

Depending on the case, the combustion plant according to the invention comprises one or more of the following features:
the production unit comprises an electrolyzer able to produce hydrogen, a cryogenic air separation unit able to produce nitrogen and means for mixing hydrogen and nitrogen;
the production unit comprises at least one ammonia cracker;
the production unit comprises at least one means for NOx removal downstream the combustion chamber; For example, a SCR (Selective Catalytic Reduction) device can be used.
the production unit comprises one of the following devices: steam methane reformer (SMR), autothermal reformer (ATR) and partial oxidation reactor;
the production unit comprises, downstream from steam methane reformer, autothermal reformer or partial oxidation reactor, a cooler, a water gas shift reactor and a carbon capture unit; the water gas shift reactor is called “CO shift reactor”;
the carbon capture unit is an absorption unit, in particular a chemical absorption unit comprising a solvent such as aqueous amine solution;
the production unit comprises upstream from the production reactor a pre-reformer;
the combustion chamber comprises at least a burner;
the combustion plant comprises means for heat recovery; For example, heat recovery from the hot flue gas leaving the combustion chamber e.g. by a combustion air preheater or a convection section to recover heat from the flue gas and heat up the feed gas.

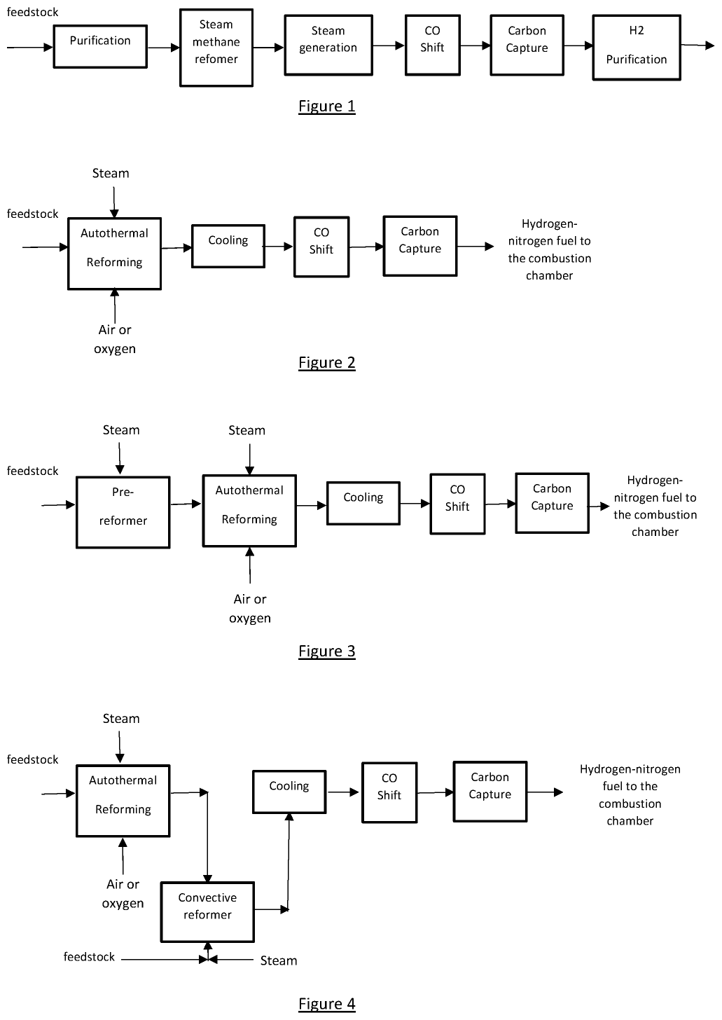

The combination of SMR with carbon capture unit is just one alternative (cf. FIG. 1). There are several possibilities for the location of a carbon capture unit, in the flue gas of the steam methane reformer, downstream the CO shift reactor or both in the flue gas stream and downstream the CO shift reactor. The fuel to the SMR reformer can be taken from feedstock or can be decarbonized product or can be a process stream such as the effluent of the carbon capture unit or a combination.

Another method to make hydrogen-nitrogen gas mixtures described in U.S. Pat. No. 1,901,884, uses a hydrocarbon feed e.g. natural gas in contact with hot cokes to generate hydrogen-nitrogen gas mixture.

Another method to make hydrogen-nitrogen gas mixtures is described in U.S. Pat. No. 1,921,856.

Another method to make hydrogen-nitrogen gas mixtures is described in U.S. Pat. No. 2,996,458.

Another method to make hydrogen-nitrogen gas mixture is by ammonia cracking as described in U.S. Pat. No. 5,976,723. A disadvantage of ammonia cracking is that the hydrogen-nitrogen gas effluent contains ammonia traces.

Another method is to use autothermal reforming with air or oxygen enriched gas (cf. FIG. 2).

This method is efficient and gives suitable hydrogen-nitrogen fuel gas quality as in the table 1:

TABLE 1

| | | | | |
|---|---|---|---|---|
| Oxygen enrichment vol % | 100 | 38 | 28 | 21 |
| O2 | | | | |
| H2 vol % | 97 | 80 | 77 | 60 |
| N2 vol % | 0 | 19 | 22 | 39 |
| CO + other vol % | 3 | 1 | 1 | 1 |

Oxidative steam reforming combines traditional steam reforming with some additional amount of air or oxygen to provide a supplementary source of exothermic reaction heat to assist in the completion of the steam conversion reactions. It is possible to balance the amount of heat released by exothermic partial oxidation with the endothermic energy consumption from the steam reforming reactions such that the reaction is theoretically self-sustaining. This process is known as Autothermal reforming and the net enthalpy change for the process is zero.

The corresponding plant contains a partial oxidation reactor combined with steam methane reforming catalyst, a syngas cooler, CO-shift reactor(s) and a carbon capture unit. Optional a feed treatment can be added such as de-chlorination catalyst and or de-sulfurization catalyst.

The CO-shift reactor can have high temperature shift catalyst, medium temperature shift catalyst or low temperature shift catalyst or a combination of two or more catalyst. High-temperature shift catalysts typically operate on an inlet temperature of 320-350° C. for bulk conversion of carbon monoxide to hydrogen, with typical exotherm of 50-80° C. and consist primarily of magnetite (Fe₃O₄) with three-valent chromium oxide (Cr₂O₃) added as a stabilizer. The catalyst is usually supplied in the form of ferric oxide (Fe₂O₃) and six-valent chromium oxide (CrO₃) and is reduced by the hydrogen and carbon monoxide in the shift feed gas as part of the start-up procedure to produce the catalyst in the desired form. However, caution is necessary since if the steam/carbon ratio of the feedstock is too low and the reducing environment is too strong, the catalyst can be reduced further to metallic iron.

Medium-temperature shift catalysts operate typically with inlet temperatures of around 240° C. and are copper based catalysts.

The Low-temperature shift catalyst operate typically with inlet temperatures of around 200° C. and employing copper-based catalyst, which is more sensitive to sulphur poisoning and thermal stability. Low temperature catalysts typically contain copper and zinc. They are used where very low carbon monoxide concentrations are required in the product gas. These catalysts are extremely sensitive to poisoning by sulfur compounds, and the feed gas must be thoroughly desulfurized before contacting the catalyst.

As the CO shift reaction is exothermic cooling is required between the subsequent CO-shift catalyst beds.

Alternative, the combustion plant may also contain a pre-reformer reactor to increase the conversion efficiency towards hydrogen (cf. FIG. 3).

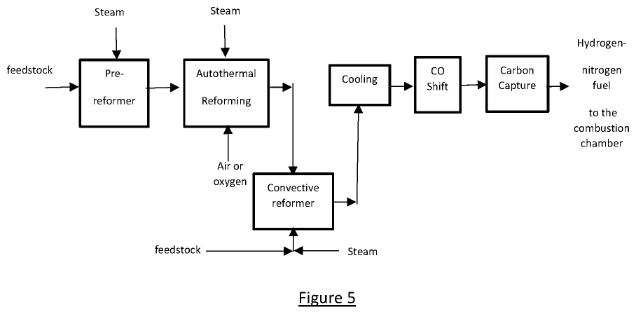

Another alternative includes a convective (or parallel) reformer as described in e.g. EU 85110117 (cf. FIG. 4).

The parallel reformer uses heat of the effluent of the partial oxidation effluent to produce more hydrogen.

Another alternative includes a pre-reformer and a convective reformer (cf. FIG. 5).

Another variant uses partial oxidation of hydrocarbon with air or oxygen enriched gas.

Partial oxidation of hydrocarbons occurs when a sub-stoichiometric amount of oxygen is supplied to the reaction thus causing partial combustion to occur. Like combustion, partial oxidation is also an exothermic reaction, however; the amount of heat released is considerably less than the heat release caused during complete combustion of the fuel. The primary products are hydrogen and carbon monoxide (also known as synthesis gas).

The corresponding plant of this variant contains a partial oxidation reactor, a syngas

cooler, CO-shift reactor(s) and a carbon capture unit. Optional a feed treatment can be added such as de-chlorination catalyst and or desulfurization catalyst. The CO-shift reactor can have high temperature shift catalyst, medium temperature shift catalyst or low temperature shift catalyst or a combination of two or more catalyst. As the CO shift reaction is exothermic cooling is required between the subsequent CO-shift catalyst beds.

Alternative, the corresponding plant of this variant may also contain a pre-reformer reactor to increase the conversion efficiency towards hydrogen.

Oxygen enrichment is known as increased percentage of O2 in air. The process for oxygen enrichment can be done by using either cryogenic distillation or non-cryogenic method such as pressure swing adsorption (PSA) or membrane separation technologies. Non-cryogenic methods are generally less energy intensive than cryogenic distillation and can lead to lower energy requirements and cost compared to air separation processes.

Power consumption for oxygen enrichment method through membrane separation is typically 0.30-0.70 kWh/Nm3 EPO2 (equivalent pure oxygen), depending on the capacity. Current membrane

separation units can produce enriched oxygen with oxygen content up to 40%. While, the power consumption for achieving the same % O2 enriched air with cryogenic process can be 0.30-0.55 kWh/Nm3 EPO2. PSA is described to be more energy intense (˜1.00 kWh/Nm3 EPO2), but it is a more mature technology.

The air separation can be described by two main methods, either by directly achieving the

preferable percentage of oxygen enriched air or by mixing the equivalent amount of pure oxygen with atmospheric air to obtain the preferable oxygen concentration in air. To produce a 75:25 H2:N2 fuel mixture by autothermal reforming, 25-45% O2-enriched air would be needed, depending on the overall process conditions, while in the case of 80:20 ratio, 30-50% O2-enriched air is required. According to the selected enrichment method, the energy efficiency of the overall system can be improved.

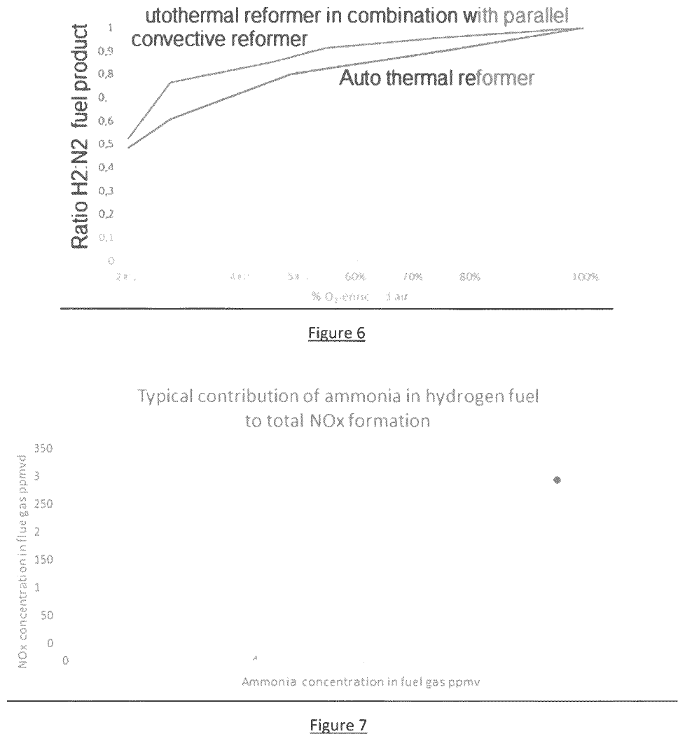

To produce a 75:25 H2:N2 fuel mixture by autothermal reforming combined with parallel convective reformer much lower % O2-enriched air would be needed as shown in FIG. 6.

FIG. 6 depicts ratio H2:N2 in fuel product versus oxygen content in O2 enriched air. A curve is shown for a plant with autothermal reformer and for a plant with autothermal reformer in combination with a parallel convective reformer.

Concerning burner, a wide range of burner types is available and could be used in the present invention, but the selection of the most suitable burner depends on several factors.

One of the first considerations in the selection of a burner is the range of fuels to be fired. Burners for process heaters must be able to bum a wide range of fuels. Further, the materials being processed have a limiting heat flux. The required degree of uniformity of heat must be established before considering burner selection. Flame impingement and local overheating of the furnace tubes should be avoided. There should be adequate space for complete combustion.

The burner must be capable of meeting the maximum heat demand and have sufficient flexibility to meet any variations (tum-down performance).

The air pollutants normally considered are sulphur oxides, nitrogen oxides, carbon monoxide, unburned hydrocarbons and particulates. The burners must be able to fire all the available fuels in a safe, efficient, reliable and environmentally clean manner.

In forced draft burners the combustion air is forced at pressure through an annulus at the burner head. The fuel is injected through tips into the air stream where it mixes and burns. Forced draft burners are used for gas, oil or combination firing. The required air pressure ranges from 30 to 250 mm H2O. The flames of forced draft burners can be designed to burn more intense with a shorter flame than flames of natural draft burners.

In natural draught burners, the air is drawn through the burner by the furnace draught. Natural draft burners can be used for gas, oil or combination firing. A disadvantage is that the gas/air ratio of this burner cannot be controlled accurately. The pressure loss across the burner is typically 5 to 15 mm H2O, limited by the available draught in the heater.

In premix burners, combustion air is inspirated by the fuel gas pressure (self-inspirating, premix type). This principle is often used for radiant sidewall burners. An advantage of premix burners is that some control of fuel/air ratio is achieved with changing heat release, because the air flow varies with the fuel flow. Disadvantages of premix burners are:
the fuel gas composition must be of constant quality to avoid a poor gas/air ratio;
risk of ‘flash back’ at low capacity;
risk of ‘blow off’ at high capacity;
typical turndown ratio is three-to-one.

‘Blow off’ is the expression used when the flow speed is so high, the flame cannot be stabilized (kept at a fixed location), and so the flame propagates downstream.

Turndown of a burner is the ratio between the maximum and minimum firing rate.

Fuel and combustion air do not mix until they leave the discharge port. This eliminates the problem of flash back. The fuel/air mixture starts to bum at a (metal) flame holder or at the cone (refractory) of the burner. The burners may be forced draft or natural draft. The tumdown ratio can be ten-to one.

A wide range of fuel gas qualities can be burned because the fuel and air flows are independent.

The length of the flame shall not exceed more than ⅔ of the firebox height to avoid overheating of the convection section tubes. Adequate lateral clearance must be provided between the edge of the flame and the front face of the radiant tubes. Standards such as API-560 give recommendations for these clearances.

When the theoretically required amount of combustion air is supplied in normal practice, combustion will not be complete because ideal mixing cannot be achieved in commercial burners.

Therefore, an extra quantity of air must always be supplied. The amount of excess combustion air is usually expressed as a percentage of the amount of air which would theoretically be required.

The amount of excess air which must be supplied to avoid a smoky flame and/or carbon monoxide in the flue gas largely depends on the type of burner and fuel. The disadvantage of high excess combustion air is the resulting low efficiency of the combustion chamber (or firebox). The excess combustion air lowers the temperature of the flame and the flue gas and consequently the amount of heat transferred to the process stream, resulting in a lower firebox efficiency. Further, the extra combustion air must be also heated up to the flue gas temperature at the stack, reducing the available heat to the process steam in the convection section. Typical design excess combustion air levels for gaseous fuels are 5-10% for forced draught burners and 10-20% for natural draught burners.

In fuel gas combustion, the main source of NOx formation is the reaction of the atmospheric nitrogen and oxygen at high temperature (e.g Zeldovich mechanism). The reactions, which may also involve radicals formed during the combustion process, are highly temperature dependent, there being little thermal NO formed below 1300° C. but an exponential increase thereafter.

When the fuel itself contains nitrogen compounds (eg HCN), NOx will also be formed by reaction of these compounds with oxygen. The inventors found that presence of e.g. ammonia in the fuel gas increase NOx formation. Please refer to the FIG. 7 for the effect of ammonia content in the fuel gas on NOx emission.

The following parameters control the NOx formation in fired process heaters and furnaces:
Excess combustion air level
Combustion air preheat temperature
Fuel quality
Fuel Nitrogen (bounded) content increases NOx formation

The techniques to reduce the NOx formation are essentially those which limit oxygen availability to the fuel and/or peak flame temperatures.

The following techniques are often used in burner design to lower the formation of nitrogen oxides:
staged combustion (air staging or fuel staging)
Flue gas recirculation (internal or external)
Steam/Water injection

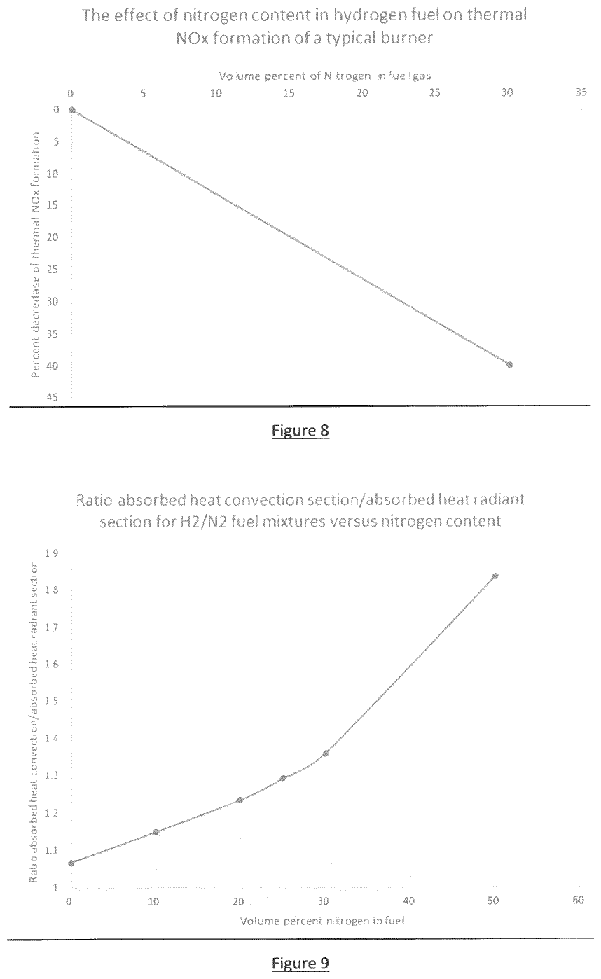

The inventors found that in addition to the above techniques fuel gas dilution with inert nitrogen gas reduces NOx emission in process furnace burners. FIG. 8 depicts the effect of nitrogen content in hydrogen fuel on thermal NOx formation of a typical low NOx burner.

Further, the inventors found that inert nitrogen gas significantly reduces the flame speed of

hydrogen fuels as shown in the table 2:

TABLE 2
Flame speed of hydrogen - nitrogen fuel mixtures

| Fuel composition | H2 | H2 + 20% N2 | H2 + 25% N2 | H2 + 30% N2 | H2 + 50% N2 |
|---|---|---|---|---|---|
| H2 vol % | 100 | 80 | 75 | 70 | 50 |
| N2 vol % | 0 | 20 | 25 | 30 | 50 |
| Total | 100 | 100 | 100 | 100 | 100 |
| Molecular weight | 2.0 | 7.2 | 8.5 | 9.8 | 15.0 |
| kg/kmol | | | | | |
| Weaver flame | 2.4 | 1.7 | 1.5 | 1.4 | 0.9 |
| speed m/s | | | | | |
| LHV kJ/kg | 120000 | 26800 | 21300 | 17200 | 8050 |

Adding a small amount of nitrogen in the hydrogen fuel significantly reduces the fuel flame speed and as a result reduces the risk of flashback in premix burners. Further, nitrogen gas in the fuel acts as a dilutant that reduces NOx emission. Another advantage of nitrogen in the fuel gas is that the production cost of lower purity carbon free fuel is much lower than the cost of pure hydrogen fuel. Because of the above is recommended to use hydrogen-nitrogen fuel mixtures in the range

hydrogen+5 vol % nitrogen up to hydrogen+50 vol % nitrogen. Preferably the hydrogen-nitrogen fuel mixture shall be in the range hydrogen+20 vol % nitrogen up to hydrogen+30 vol % nitrogen.

Concerning furnaces, fired process heaters are widely used in industry for heating liquids, gases and for vaporizing duties. The process fluid inside the tubes is heated by means of radiative and convective heat transfer from hot combustion gases. Process heaters can be gas, oil or dual fired. The fluid outlet temperatures are normally in the range of 200° C. to 1000° C. and the unit size may vary from about 0.3 MW to 500 MW absorbed duty.

A typical list of duties is:
Hot Oil Heaters,
Refinery Charge Heaters
Reactor Charge Heaters
Fired Reboilers
Regeneration Heaters
Cracking Furnaces
Reforming Furnaces
Direct Reduction Iron (DRI) heaters, that heat reducing gases for the production of Iron.

Note all these furnaces can be concerned by the present invention.

Cracking and reforming furnaces involve chemical reactions taking place inside the tubes.

A fired process heater consists of the following components:
Firebox, containing the radiant tubes and the burners and is sometimes referred to as the Radiant Section
Convection Section
Burners
Combustion Air Preheating
Tube support and Cross-over
Flue Gas and Combustion Air Fans, sometimes referred to as Induced Draught (ID) and Forced Draught (FD) Fans
Stack

Not all heaters have all the above components. A wide variety of layouts is possible. A common arrangement is a firebox, convection section and a stack.

Furnaces and fired heaters have temperature limitations such as operating pressure, fluid

operating temperature and heater tube wall temperature. In contrast gas turbines generally operate at higher pressures and with a more limited allowable temperature, e.g. maximum Turbine Inlet Temperature, due to so-called creep limitations of the materials used in gas turbines.

The inventors found that the absorbed heat duty of the convection section and absorbed heat duty of the radiant sections change when the fuel composition changes. Pure hydrogen fuel produces a lower flue gas mass compared to conventional natural gas fuels. Because of this, the flue gas leaving the furnace radiant section have less heat enthalpy. The convection section duty is therefore lower if pure hydrogen fuel is used in the burner. On the other hand, the radiant section duty will increase resulting in high heat flux in the radiant tubes and risk of overheating.

The inventors found by rigorous SPYRO® software simulations that a nitrogen-hydrogen fuel with a nitrogen gas content of 25 vol % has the same ratio absorbed heat convection/absorbed heat radiant section as for methane fuel. Further, inventors found that a nitrogen-hydrogen fuel with a nitrogen gas content of 25 vol % could be used in a commercial industrial premix burner, whereas pure hydrogen fuel was unsuitable in this type of premix burners due to high burning velocity of hydrogen fuel. FIG. 9 depicts the ratio heat convection section/absorbed heat radiant section for H2/N2 fuel mixtures versus nitrogen content of a standard ethylene cracking furnace. Often ethylene cracking furnaces are designed for natural gas fuel as a (start-up) design fuels. For natural gas fuel, the ratio absorbed heat convection/absorbed heat radiant section is 1.3. The FIG. 9 shows that nitrogen-Hydrogen fuel with a nitrogen content of 25 vol % has the same ratio absorbed heat convection/absorbed heat radiant section as for methane (or natural gas) fuel.

For most applications a hydrogen fuel gas mixture with a nitrogen content in the range 20 vol %-30 vol % gives the same ratio absorbed heat convection/absorbed heat ratio radiant section. For this reason, fuel gas mixtures with a nitrogen content in the range of 20 vol %-30 vol % are preferred.

The present invention has the following advantages:
The ratio absorbed heat radiant section-absorbed heat convection section is the same as for natural gas fuel. The heat flux of the heat transfer area in the radiant section does not change.
The fuel flame speed is much lower than for pure hydrogen fuel so that in many cases conventional premix burners can be used with minor adjustment of the fuel orifice.
Hydrogen/nitrogen fuel mixtures can be manufactured at low cost compared to pure hydrogen.
Nitrogen gas in the fuel act as inert gas and lowers the peak flame temperature of the combustion. This reduces formation of nitrogen oxides.

Alternative solutions are pure hydrogen firing, ammonia firing and oxyfuel combustion. Pure hydrogen firing has the disadvantage of high fuel cost. Further pure hydrogen firing requires special nozzle mix burners suitable for hydrogen fuel. Pure hydrogen firing has a higher ratio absorbed duty in the radiant section to absorbed duty in the convection compared to natural gas fuel. This can limit furnace capacity. Ammonia fuel firing has the disadvantage that heat of combustion of ammonia is quite low. Further, the high emission of nitrogen oxides and unburned ammonia is a challenge so that an expensive selective catalytic DeNOx reactor will be needed. Oxyfuel combustion has the disadvantage that expensive oxygen is required. Oxyfuel combustion requires flue gas recirculation fans with advanced firing control and extra duct work to the burners.

Further, oxyfuel combustion requires extra carbon dioxide transport lines from the furnaces to a (remote) CO2 compressor station.

It will be understood that the expression “combustion process without carbon dioxide emission” as used herein means that the combustion product of the binary fuel gas can be essentially free of CO2, notwithstanding CO2 due to combustion of the small amount of pollutants.

In some embodiments there is provided a combustion process comprising a) a production step of a binary fuel gas consisting of hydrogen and at least of between 5 and 50 vol % of nitrogen and no pollutant or a total amount of pollutant below 1 volume %, and b) a combustion step using as only fuel gas the binary fuel gas at a combustion chamber able to receive as fuel gas the binary fuel gas.

As discussed herein the combustion process can be worked to advantage for a furnace or a fired process heater, or in alternative wording the combustion can be used to supply heat to an industrial furnace or fired process heater. For example, by supplying the binary fuel as discussed herein, as only fuel to a burner, e.g. a burner of a furnace or fired process heater, such as a burner contained within a firebox. In a preferred embodiment the combustion process is applied to a plant comprising a hydrogen/nitrogen production unit as disclosed herein, a radiant section comprising a firebox with radiant tubes, a burner placed in the firebox to burn the binary fuel, and a convection section to recover heat from flue gas from the combustion.

Related thereto the invention also provides a combustion plant. In some embodiments the plant can comprise at least i) a production unit configured to produce the binary fuel gas as defined in claim 1; and ii) a combustion chamber able to receive as only fuel gas fuel gas the binary fuel gas. The combustion chamber can be of a furnace or a fired process heater.

According to some aspects the invention provides a binary fuel gas, a combustion process, and a combustion plant, as set out in the below clauses.

Clause 1. Binary fuel gas consisting of hydrogen and at least of between 5 and 50 vol % of nitrogen.

Clause 2. Combustion process using as only fuel gas the binary fuel gas as defined in clause 1.

Clause 3. Combustion process according to clause 2, comprising:
a) a production step of the binary fuel gas,
b) a combustion step using as only fuel gas the binary fuel gas.

Clause 4. Combustion process according to clause 3, wherein the production step a) comprises an electrolysis sub-step to produce hydrogen, a cryogenic air separation sub-step to produce nitrogen and a hydrogen and nitrogen mixing sub-step.

Clause 5. Combustion process according to clause 3, wherein the production step a) comprises an ammonia cracking sub-step.

Clause 6. Combustion process according to clause 5, comprising a NOx removal sub-step.

Clause 7. Combustion process according to clause 3, wherein the production step a) comprises at least one of the following sub-steps: steam methane reforming, autothermal reforming and partial oxidation.

Clause 8. Combustion process according to clause 7, wherein the feedstock used in the production step is chosen from natural gas, Liquified Petroleum Gas (LPG), naphta, gasoil, diesel, gas condensate and biogas.

Clause 9. Combustion process according to clause 7 or clause 8, wherein the production step a) comprises the following sub-steps: a cooling sub-step, a water gas shift sub-step and a carbon dioxide removal sub-step.

Clause 10. Combustion plant comprising a combustion chamber able to receive as only fuel gas the binary fuel gas as defined in clause 1 or in clause 2.

Clause 11. Combustion plant according to clause 10, comprising:
i) A production unit of the binary fuel gas,
ii) A combustion chamber able to receive as fuel gas the binary fuel gas.

Clause 12. Combustion plant according to clause 11, wherein the production unit comprises an electrolyzer able to produce hydrogen, a cryogenic air separation unit able to produce nitrogen and means for mixing hydrogen and nitrogen.

Clause 13. Combustion plant according to clause 11, wherein the production unit comprises at least one ammonia cracker.

Clause 14. Combustion plant according to clause 13, wherein the production unit comprises means for NOx removal downstream the combustion chamber.

Clause 15. Combustion plant according to clause 11, wherein the production unit comprises one of the following devices: steam methane reformer (SMR), autothermal reformer (ATR) and partial oxidation reactor.

Clause 16. Combustion plant according to clause 15, wherein the production unit comprises, downstream steam methane reformer, autothermal reformer or partial oxidation reactor, a cooler, a water gas shift reactor and a carbon capture unit.

1. A combustion process comprising:
a) a production step of a binary fuel gas consisting of hydrogen and at least of between 5 and 50 vol % of nitrogen; and,
b) a combustion step using as only fuel gas the binary fuel gas at a combustion chamber able to receive as fuel gas the binary fuel gas, wherein the combustion chamber is a furnace or a fired process heater.

2. The combustion process according to claim 1, wherein the production step a) comprises: an electrolysis sub-step to produce hydrogen; a cryogenic air separation sub-step to produce nitrogen; and, a hydrogen and nitrogen mixing sub-step.

3. The combustion process according to claim 1, wherein the production step a) comprises an ammonia cracking sub-step.

4. The combustion process according to claim 1, comprising a NOx removal sub-step.

5. The combustion process according to claim 1, wherein the production step a) comprises at least one of the following sub-steps: steam methane reforming, autothermal reforming and partial oxidation.

6. The combustion process according to claim 5, wherein the feedstock used in the production step is chosen from natural gas, Liquified Petroleum Gas (LPG), naphta, gasoil, diesel, gas condensate and biogas.

7. The combustion process according to claim 5, wherein the production step a) comprises the following sub-steps: a cooling sub-step, a water gas shift sub-step and a carbon dioxide removal sub-step.

8. The combustion process according to claim 1 wherein the binary fuel gas has a nitrogen content within 20-30 vol %.

9. A combustion plant comprising:
i) a production unit configured to produce the binary fuel gas as defined in claim 1,
ii) a combustion chamber, selected from the group of furnaces and fired process heaters, able to receive as only fuel gas fuel gas the binary fuel gas.

10. The combustion plant according to claim 9, wherein the production unit comprises an electrolyzer able to produce hydrogen, a cryogenic air separation unit able to produce nitrogen and means for mixing hydrogen and nitrogen.

11. The combustion plant according to claim 9, wherein the production unit comprises at least one ammonia cracker.

12. The combustion plant according to claim 9, wherein the production unit comprises means for NOx removal downstream the combustion chamber.

13. The combustion plant according to claim 9, wherein the production unit comprises one of the following devices:
steam methane reformer (SMR);
autothermal reformer (ATR); and,
partial oxidation reactor.

14. The combustion plant according to claim 13, wherein the production unit comprises, downstream steam methane reformer, autothermal reformer or partial oxidation reactor, a cooler, a water gas shift reactor and a carbon capture unit.
